(19) United States
(12) Patent Application Publication
(10) Pub. No.: US 2010/0022121 A1
(43) Pub. Date: Jan. 28, 2010

(54) COAXIAL CABLE DEBRAIDING AND COAXIAL CABLE CONNECTOR SEATING TOOL

(76) Inventor: Edward Joseph BRADLEY, Livermore, CA (US)

Correspondence Address: DALINA LAW GROUP, P.C., 7910 IVANHOE AVE. #325, LA JOLLA, CA, 92037, US

(21) Appl. No.: 12/180,544

(22) Filed: Jul. 27, 2008

(51) Int. Cl. H01R 9/05

(52) U.S. Cl. 439/578

(57) ABSTRACT

Coaxial cable debraiding and coaxial cable connector seating tool enables a person to rapidly debraid coaxial cable braided shielding from coaxial cable dielectric and fully seat coaxial cable connector onto stripped coaxial cable without directly contacting braiding or coaxial cable connector with person's fingers. Cavities in tool match diameter and maximum depths of coaxial cable conductor, dielectric and coaxial cable connector and/or coaxial cable connector rotation aid. Inserting stripped coaxial cable into the tool having cavities that match the coaxial cable dimensions and rotating the tool with respect to the cable, the braiding is thus parted from the dielectric in preparation for seating. By placing the coaxial cable connector in alignment with the axis of the tool and cable and pressing the tool along the axis of the cable, the coaxial cable connector is thus fully seated on the cable and is fully prepared for crimping.

### BACKGROUND OF THE INVENTION

1. Field of the Invention

Embodiments of the invention described herein pertain to the field of coaxial cables. More particularly, but not by way of limitation, one or more embodiments of the invention enable a coaxial cable debraiding and coaxial cable connector seating tool that enables a person to rapidly debraid coaxial cable braided shielding from a coaxial cable dielectric and to fully seat a coaxial cable connector onto a stripped coaxial cable without directly contacting the braiding or coaxial cable connector with the person's fingers.

2. Description of the Related Art

Coaxial cables are utilized for connecting high frequency components together. For example, coaxial cables may be utilized to connect antennas or cable boxes to televisions. Currently, technicians preparing coaxial cables for connection perform a sequence of steps by hand. The technicians begin by stripping a coaxial cable, folding back the braiding by hand in the coaxial cable surrounding the dielectric, placing a coaxial cable connector in alignment with the coaxial cable and forcing the coaxial cable connector by hand to seat onto the coaxial cable. Once seated, the coaxial cable connector is crimped onto the coaxial cable, for example using a compression crimping tool that compresses a sleeve in the connector into a collar in the connector.

Known tools exist that allow for the stripping of the coaxial cable in rapid fashion. However, once stripped, the braiding surrounding the dielectric is still in position around the dielectric and must be forced away from the dielectric before the coaxial cable connector may be seated. Generally, technicians fold back the braiding in a time consuming manner by hand that cumulatively also tends to hurt ones fingers after debraiding many cables. In addition, the technicians seat the coaxial cable connectors by hand, and cumulatively, this too tends to hurt ones fingers after seating many coaxial cable connectors.

For at least the limitations described above there is a need for a coaxial cable debraiding and coaxial cable connector seating tool that enables a person to rapidly debraid coaxial cable braided shielding from a coaxial cable dielectric and to fully seat a coaxial cable connector onto a stripped coaxial cable without directly contacting the braiding or coaxial cable connector with the person's fingers.

### BRIEF SUMMARY OF THE INVENTION

One or more embodiments of the invention enable a coaxial cable debraiding and coaxial cable connector seating tool that enables a person to rapidly debraid coaxial cable braided shielding from a coaxial cable dielectric and to fully seat a coaxial cable connector onto a stripped coaxial cable without directly contacting the braiding or coaxial cable connector with the person's fingers.

One or more embodiments of the invention may be implemented with a cylindrical tool with cavities that match the diameter and maximum depths of a coaxial cable conductor, dielectric and coaxial cable connector, wherein the coaxial cable connector may optionally be connected or integrated with a coaxial cable connector rotation aid. Any shape may be utilized for this tool provided that the cavities present within the tool matches the desired cable size.

By inserting a stripped coaxial cable into an end of the cylindrical tool having cavities that match the coaxial cable dimensions and rotating the tool with respect to the stripped coaxial cable along the axis defined by the coaxial cable, the braiding is thus parted from the dielectric in preparation for seating. The term “parted from” may be interchanged with other terms such as “push back” or “back brush” with respect to displacing braiding from the dielectric. The end of the dielectric may be rounded or chamfered with a curve or bevel in the innermost portion of the dielectric cavity. This aids in moving the dielectric into the post portion of the coaxial cable connector.

By placing the coaxial cable connector in alignment with the axis defined by the cylindrical tool and the coaxial cable and pressing the cylindrical tool along the axis of the cable, the coaxial cable connector is thus fully seated (dielectric is fully inserted into the coaxial cable connector post) on the coaxial cable and is fully prepared for crimping.

The outer portion of the tool may include any ergonomic or textured surface to provide a coefficient of static friction great enough to allow for the rotation and translation of the device during the debraiding and seating tasks. The outer portion of the tool may also include any accommodation for securely mounting tool to a solid surface or fixture. Accommodations may include but are not limited to machined grooves or flats, screw holes or brackets.

Uses for embodiments of the invention include high volume cable factories, installation technicians, and any other person that desires to quickly and efficiently prepare a coaxial cable of any type for use in connecting the coaxial cable to a coaxial cable port.

### BRIEF DESCRIPTION OF THE DRAWINGS

The above and other aspects, features and advantages of the invention will be more apparent from the following more particular description thereof, presented in conjunction with the following drawings wherein:

FIG. 1 shows a typical coaxial cable connector and four embodiments of a coaxial cable connector rotation aid that may be utilized with embodiments of the invention.

FIG. 2 shows a side view of an embodiment of the coaxial cable debraiding and coaxial cable connector seating tool.

FIG. 3 shows an end view of an embodiment of the coaxial cable debraiding and coaxial cable connector seating tool.

FIG. 4 shows various stages of coupling a coaxial cable rotation aid to a coaxial cable.

FIG. 5 shows a cutaway view of an embodiment of the coaxial cable debraiding and coaxial cable connector seating tool and shows dimensions associated with a standard coaxial cable and coaxial cable connector and in addition, shows dimensions associated with a coaxial cable coupled with a coaxial cable rotation aid.

### DETAILED DESCRIPTION

A coaxial cable debraiding and coaxial cable connector seating tool will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

In the context of this document, the term debraiding is taken to mean the folding back of shield braiding present between the outer insulation and the inside dielectric of a coaxial cable, where the folding allows for application of a coaxial cable connector directly to the cable using the described embodiments of the invention.

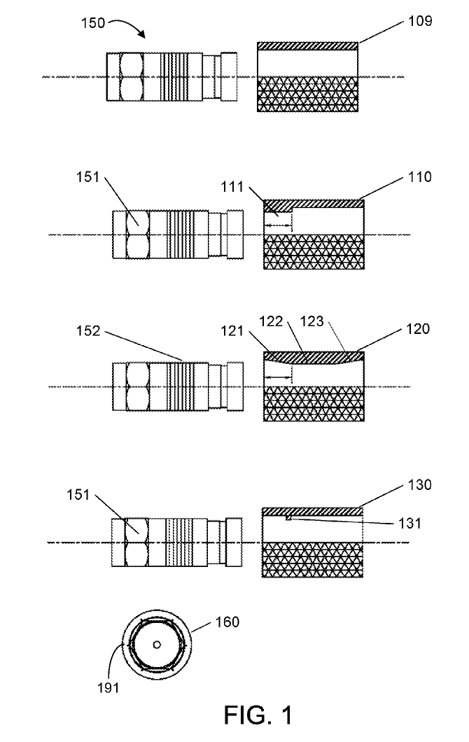

FIG. 1 shows four embodiments of a coaxial cable connector rotation aid that may be utilized with embodiments of the invention. Any other type of coaxial cable connector rotation aid that is configured for crimping may be utilized with embodiments of the invention that are sized based on the outer diameter of the desired aid in order to bring the longitudinal axis of the tubular aid in alignment with the coaxial cable connector to couple with. Aid 100 is a hollow cylinder with an internal diameter dimension large enough to accommodate any type of coaxial cable connector. In this case, the inner diameter dimension is 12.45 mm. Through use of a soft metal for aid 100, crimping aid 100 onto coaxial cable connector 150 is performed with minimal effort. Aid 110 includes a narrower inner portion 111 to provide a tighter fit with nut 151 for example. Aid 120 provides a 6.5 mm deep ramp 121 into aid 120, wherein the innermost area 122 is large enough to accommodate collar 152, while opposing side ramp 123 allows for non-rotatable coupling with the opposing coaxial cable connector on the opposing side of the cable. Aid 130 provides stop 131 to provide a limit to the depth at which nut 151 can be displaced into aid 130. Other aids, such as plastic aids, may also be utilized with embodiments of the invention and in so doing lowers the time and increases the quality of the resulting crimped combination.

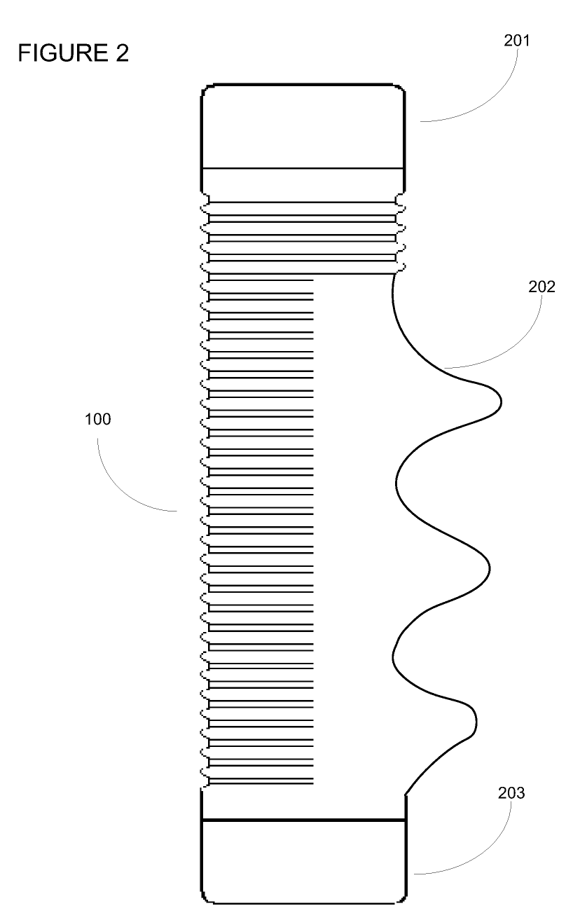

FIG. 2 shows a side view of an embodiment of the coaxial cable debraiding and coaxial cable connector seating tool 100. Handle end, i.e., end 201 may be configured for example to allow for debraiding and seating of a coaxial cable and coaxial cable connector respectively. Optional handle 202 allows for gripping the tool during debraiding and seating. Handle 202 may be replaced by any suitable material, for example knurled areas, or indentations for example that provide a sufficient coefficient of static friction so long as the debraiding and seating may be accomplished. The optional handle may also be configured to provide ease of use to the operator, such as providing ergonomic handles for example. Handle 202 may also be optionally textured to provide comfort or improved grip to provide a high enough coefficient of static friction to allow for rotation and translation of the tool about and along an axis defined by the longest dimension of the tool and with respect to the cable to which the tool is applied. End 201 may be configured for example to allow for debraiding and seating of a coaxial cable and coaxial cable connector coupled with a coaxial cable connector rotation aid (see FIG. 1) respectively. Handle end 201 or any other portion of the tool body may include a mounting element, i.e., may be machined with grooves, flats or screw holes or affixed with a bracket for the purpose of securely mounting tool to a solid surface or fixture.

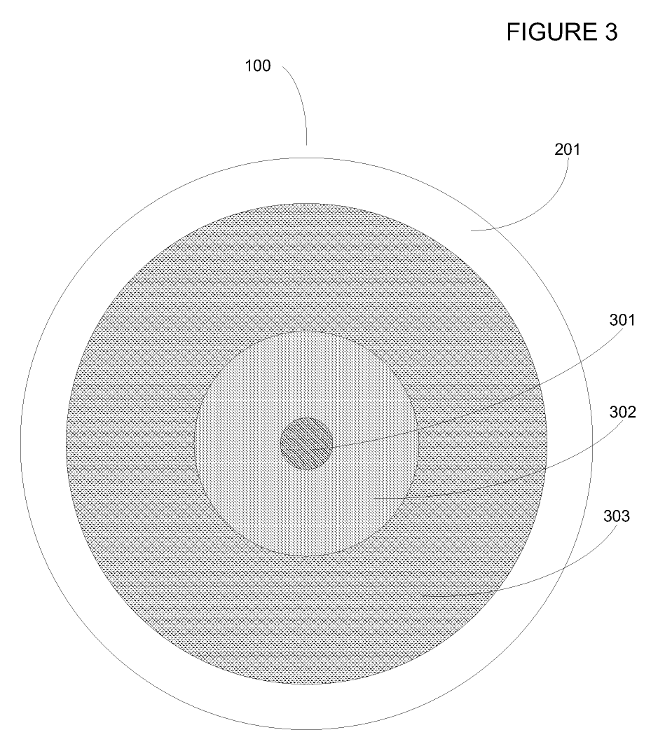

FIG. 3 shows an end view of an embodiment of the coaxial cable debraiding and coaxial cable connector seating tool 100. Conductor cavity 301 is shown as the deepest hole in the tool. This allows for the conductor to enter furthest into the tool. Dielectric cavity 302 is roughly the size of the dielectric, not as deep as conductor cavity 301, and may be any diameter so long as the dimension excludes the braiding that surrounds the dielectric yet allows the dielectric to enter dielectric cavity 302. Upon entry of the dielectric into dielectric cavity 302 and optionally by rotating tool 100, the braiding is thus forced away from the dielectric in preparation for seating. Dielectric cavity 302 may be implemented with a rounded edge or bevel in the bottom of dielectric cavity 302 to create a slight rounding of the outer edges of the dielectric when fully inserted into dielectric cavity 302 which aids in seating the dielectric into the coaxial cable connector post. Seating cavity 303 provides a cavity of a diameter that allows for entry of the coaxial cable connector and provides a face at the innermost portion of seating cavity 303 that allows force to be imparted to the coaxial cable connector that opposed the force of the cable when the coaxial cable connector and cable are forced together using coaxial cable debraiding and coaxial cable connector seating tool 100.

Embodiments of the invention may be constructed from any durable material including but not limited to metal and plastic so long as coaxial cable debraiding and coaxial cable connector seating tool does not break during debraiding and seating.

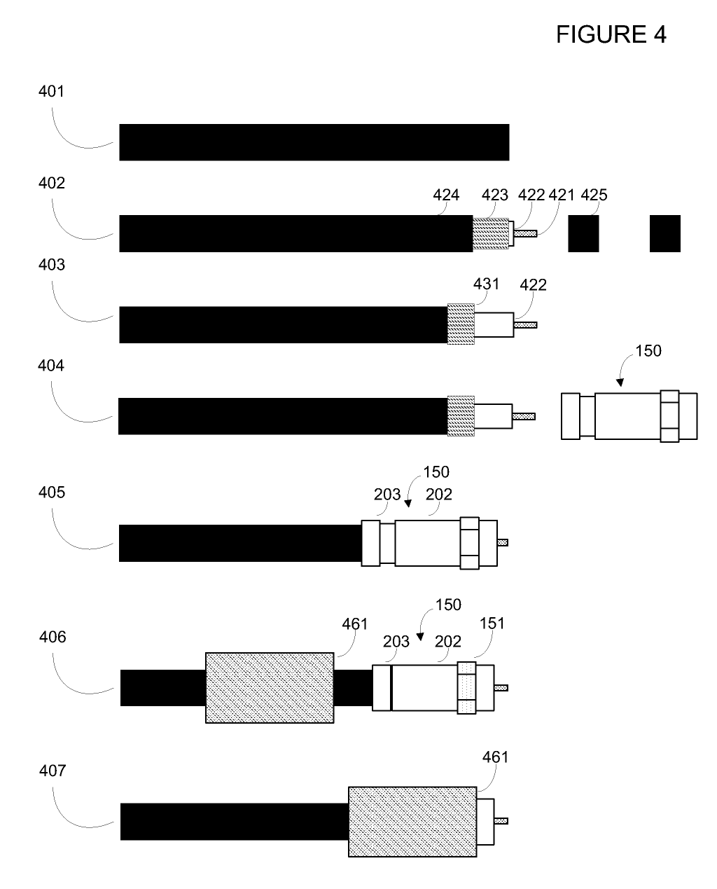

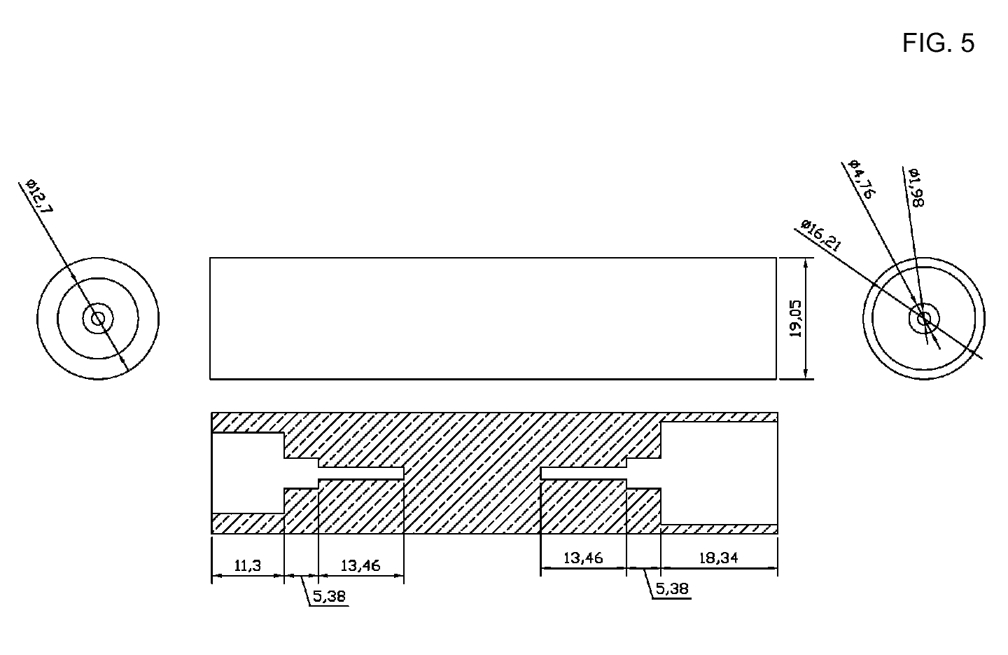

FIG. 4 shows the various stages of coupling a coaxial cable rotation aid to a coaxial cable. Coaxial cable 401 is shown with an unprepared left hand end that is not square, while the right hand side of coaxial cable 401 is shown in a prepared state having a clean cut end that is perpendicular to the axis along coaxial cable 401. Stripped coaxial cable 402 is shown as stripped with a ¼ inch by ¼ inch stripping tool. As shown, outer insulating jacket 424, shield braiding 423 and dielectric 422 are cut away on the far right, thereby leaving conductor 421 exposed. In addition, the stripping tool also cuts outer insulating jacket 424 down to shield braiding 423, which is also shown removed as removed outer shield braiding 425. Coaxial cable debraiding and coaxial cable connector seating tool 100 is utilized in debraiding stripped coaxial cable 402 by placing conductor 421 into conductor cavity 301 (see FIG. 3), wherein the dielectric enters dielectric cavity 302 which forces braiding 431 away. Rotating the coaxial cable debraiding and coaxial cable connector seating tool 100 may be utilized in aiding in the debraiding. The braiding is thus shown folded back at 431 away from dielectric 422 on prepared coaxial cable 403 in preparation for seating coaxial cable connector 150, which is placed in line with correctly aligned and prepared coaxial cable 404. Coaxial cable debraiding and coaxial cable connector seating tool 100 is utilized in seating by placing coaxial cable connector 150 on debraided, i.e., fully prepared coaxial cable 405 and pressing the cable against the tool wherein dielectric 422 is forced into the coaxial cable connector post until it travels no further, wherein the coaxial cable connector is seated and ready for crimping, i.e., a seated coaxial cable connector. A crimping tool is utilized to compress coaxial cable connector 150 to yield fully coupled coaxial cable 406 wherein the coaxial cable connector sleeve and collar are fully engaged, therein fixedly attaching the sleeve and collar to the coaxial cable. Coaxial cable connector rotation aid 461 is placed onto the bare end, i.e., opposing end of fully coupled coaxial cable 406 and crimped onto nut 151 thereby producing coaxial cable connector rotational aid end 407. By preparing and coupling another coaxial cable connector to the opposing (left side as shown) of end 407, coaxial cable connector rotation aid 461 may be crimped onto the opposing nut by sliding coaxial cable connector rotation aid 461 off of nut 151 manually and moving coaxial cable connector rotation aid to the opposing side. The grooves carved into each side allow for a non-rotational coupling with respect to nut 151 and a rotational coupling with respect to outer insulating jacket 424. For embodiments of the coaxial cable connector that are integrated with coaxial cable connector rotation aid 461, opposing end of coaxial cable debraiding and coaxial cable connector seating tool 100 may be implemented with a diameter for seating cavity 303 that allows for entry of coaxial cable connector rotation aid 461. (See FIG. 5 right hand side).

FIG. 5 shows a cutaway view of an embodiment of the coaxial cable debraiding and coaxial cable connector seating tool and shows dimensions associated with a standard coaxial cable and coaxial cable connector and in addition, shows dimensions associated with a coaxial cable coupled with a coaxial cable rotation aid. As shown, the diameter for conductor cavity 301 is 1.98 mm, while the diameter for dielectric cavity 302 is 4.76 mm, while diameter for the coaxial cable connector for use with coaxial cable connector 150 (left side of the figure) is 12.7 mm and the opposing end for use with coaxial cable connector rotation aid 461 is 16.21 mm. The depths for the cavities are also shown as 13.46 mm for conductor cavity 301, 5.38 mm for dielectric cavity 302, and 11.3 mm for seating cavity 303. For the coaxial cable connector rotation aid 461 end, the depths are 13.46 mm for conductor cavity 301, 5.38 for dielectric cavity 302 and 10.34 mm for seating cavity 303 for coaxial cable connector rotation aid 461.

Embodiments of the invention can be resized for mini-coax, RG-6, RG-11, RG 58, RG-58c, RG-59 or any other coaxial cable type.

While the invention herein disclosed has been described by means of specific embodiments and applications thereof, numerous modifications and variations could be made thereto by those skilled in the art without departing from the scope of the invention set forth in the claims.

1. A coaxial cable debraiding and coaxial cable connector seating tool comprising:
a tool body;
a conductor cavity displaced within said tool body and configured to allow entry of a coaxial cable conductor;
a dielectric cavity displaced within said tool body and configured to allow entry of a coaxial cable dielectric and exclude entry of a coaxial cable braid that surrounds said coaxial cable dielectric wherein said conductor cavity is further displaced into said tool from said dielectric cavity;
a seating cavity displaced within said tool body and configured to allow entry of a coaxial cable connector into said tool body and oppose a force imparted from said coaxial cable connector as said coaxial cable connector is seated on a coaxial cable.

2. The coaxial cable debraiding and coaxial cable connector seating tool of claim 1 further comprising:
a grip coupled to the exterior of said tool body.

3. The coaxial cable debraiding and coaxial cable connector seating tool of claim 2 further comprising an ergonomic grip.

4. The coaxial cable debraiding and coaxial cable connector seating tool of claim 2 further comprising a textured grip.

5. The coaxial cable debraiding and coaxial cable connector seating tool of claim 2 further comprising an extruded grip.

6. The coaxial cable debraiding and coaxial cable connector seating tool of claim 2 further comprising a mounting element coupled to said tool body.

7. The coaxial cable debraiding and coaxial cable connector seating tool of claim 1 further comprising:
a bevel in an innermost portion of said dielectric cavity configured to round an end of said coaxial cable dielectric when said coaxial cable dielectric is inserted fully into said dielectric cavity.

8. A method for coaxial cable debraiding and connector-seating comprising:
accepting a stripped coaxial cable comprising a conductor, dielectric that surrounds said conductor, a braid that surrounds said dielectric and an insulator that surrounds said braid wherein said conductor is accepted into a conductor cavity of a tool, and said dielectric is accepted into a dielectric cavity of said tool;
debraiding said braid that surrounds said dielectric by excluding said braid from said dielectric cavity to form a debraided cable;
accepting a coaxial cable connector into a seating cavity in said tool; and,
seating said coaxial cable connector onto said debraided cable through force imparted from said seating cavity to said coaxial cable connector to form a seated coaxial cable connector.

9. A method for coaxial cable debraiding and connector-seating comprising:
accepting a stripped coaxial cable comprising a conductor, dielectric that surrounds said conductor, a braid that surrounds said dielectric and an insulator that surrounds said braid wherein said conductor is accepted into a conductor cavity of a tool, and said dielectric is accepted into a dielectric cavity of said tool; and,
debraiding said braid that surrounds said dielectric by excluding said braid from said dielectric cavity to form a debraiding cable.

10. A method for coaxial cable debraiding and connector-seating comprising:
accepting a coaxial cable connector into a seating cavity in said tool; and,
seating said coaxial cable connector onto said debraided cable through force imparted from said seating cavity to said coaxial cable connector to form a seated coaxial cable connector.

11. (canceled)
